(19) United States
(12) Patent Application Publication
(10) Pub. No.: US 2026/0249666 A1
(43) Pub. Date: Aug. 27, 2026

(54) Thermal Management Module for a Vehicle

(71) Applicant: MAHLE International GmbH, Stuttgart (DE)

(72) Inventors: Gerrit WÖLK, Stuttgart (DE); Holger ULRICH, Korntal-Münchingen (DE); Witalie GRAF, Eberdingen (DE)

(21) Appl. No.: 19/544,131

(22) Filed: Feb. 19, 2026

(30) Foreign Application Priority Data
Feb. 21, 2025 (DE) 102025106765.1

(51) Int. Cl. B60H 1/32

(52) U.S. Cl. CPC B60H 1/3229; B60H 1/32284

(57) ABSTRACT

A thermal management module for a motor vehicle is provided and has a closed refrigerant circuit with at least two heat exchangers for exchanging heat between the refrigerant and a coolant flowing separately through the heat exchangers, and a component mount to which at least one of the heat exchangers is attached. A channel structure with at least two fluid paths in the refrigerant circuit is formed in the component mount, the component mount contains at least two vertically (SR) stacked channel plates forming the channel structure, which are between two cover plates. A separate fluid-conducting element is placed on the first cover plate, in which at least one more fluid path is formed that is connected to the channel structure in the component mount.

### CROSS REFERENCE TO RELATED APPLICATIONS

This application claims priority from German Patent Application No. DE 102025106765.1, filed on Feb. 21, 2025, the entirety of which is incorporated by reference herein.

The present invention relates to a thermal management module for a motor vehicle and a motor vehicle with such a thermal management module.

Thermal management modules for controlling the temperatures of vehicle components contain a closed refrigerant circuit. There is also a separate coolant circuit. The coolant can be used to control the temperature of various vehicle components and the vehicle interior. The refrigerant circuit is used to control the temperature of the coolant in the coolant circuit, specifically by absorbing heat therefrom. This normally takes place in two heat exchangers in the thermal management module, which are both located in the refrigerant circuit and in the coolant circuit, thus thermally coupling both circuits in the two heat exchangers. This allows heat to be exchanged between the refrigerant and the coolant. It has proven to be advantageous when the closed refrigerant circuit is not connected to the vehicle components that need to be cooled, and also does not pass through the vehicle interior, which is frequently no longer allowed in modern vehicles for safety and legal reasons.

Motor vehicles normally do not have a lot of room for such a thermal management module. This can be problematic, particularly because of the complex fluid line configuration for the refrigerant circuit and the coolant circuit.

Conventional thermal management modules have a component mount for this reason, to which not only various functional components in the thermal management module are attached, but also in which a channel structure is formed, forming part of the refrigerant circuit. This channel structure comprises fluid paths for the refrigerant that are in contact with the functional components of the thermal management module, thus conveying refrigerant to and from them.

Unfortunately, the integrated fluid paths in this component mount are frequently inadequate for the thermal management module, due to the lack of available installation space in motor vehicles.

The object of the present invention is to therefore find new ways of improving thermal management modules. In particular, a better thermal management module is to be obtained that at least partially, ideally entirely, resolves the aforementioned problems regarding the limited available installation space for complex fluid lines.

It is therefore the object of the present invention to create a better design for an assembly containing a compressor and the thermal management module described above that at least partially, preferably entirely, resolves the aforementioned problems.

These problems are solved by the subject matter of the independent Numbered Paragraphs. Preferred embodiments are the subject matter of the dependent Numbered Paragraphs.

The fundamental idea is to therefore supplement the component mount for a thermal management module with an additional fluid-conducting element that contains at least one additional fluid path.

This fluid-conducting element can be separate from the component mount, thus supplementing and extending the channel structure therein.

Although the component mount in the thermal management module normally contains plates that are stacked to form the channel structure, the shape of the fluid-conducting element can be adapted to specific installation spaces.

This allows space in the vehicle that is not suitable for the component mount to be used for the fluid-conducting element intended for the refrigerant.

This fluid-conducting element is a separate component from the component mount. This simplifies production thereof, because the fluid-conducting element and the component mount can then be produced separately. Specifically, the typically fairly complex channel structure in the component mount can be produced with other methods than those used for production of the supplementary fluid path in the fluid-conducting element. The component mount can be formed by stacking numerous plates to form the channel structure, which are then brazed together.

The fluid-conducting element is then ideally placed on a cover plate on the component mount. This assembly requires very little installation space.

In accordance with this concept, the thermal management module obtained with the invention contains a closed refrigerant circuit. This refrigerant circuit contains at least two heat exchangers in which heat is exchanged between the refrigerant and a coolant flowing separately therethrough.

This thermal management module contains a component mount to which at least one of the heat exchangers is attached. Ideally, all of the heat exchangers are attached to the component mount.

The component mount in the thermal management module obtained with the invention contains at least two fluid paths for refrigerant within the refrigerant circuit. The component mount is formed by at least two stacked plates that form the channel structure for the fluid paths. These channel plates are between two cover plates. The channel plates and cover plates can be bonded together, specifically by brazing.

A separate fluid-conducting element is placed on the first of the two cover plates, in which at least one additional fluid path is formed that is connected to the channel structure in the component mount. The component mount and fluid-conducting element are therefore made of at least two parts. The component mount could also be composed of numerous parts, resulting in the component mount and fluid-conducting element comprising at least three parts.

The thermal management module can be part of a motor vehicle in which there is a coolant circuit that is separate from the refrigerant circuit. In this case, the coolant circuit and refrigerant circuit are thermally coupled to one another by the two heat exchangers in the thermal management module.

The fluid-conducting element can be an extruded or cast component. Consequently, it can be produced inexpensively, thus reducing the overall production costs for the thermal management module obtained with the invention.

At least one of the fluid paths formed in the fluid-conducting element can be open, such that it is closed by the first cover plate on the component mount. This design simplifies production, in that the path can be formed by a milling process.

At least one other fluid path can also be formed by milling in the fluid-conducting element. Preferably, all of the fluid paths in the fluid-conducting element are formed by milling.

The fluid-conducting element can have at least one port for a functional component in the thermal management module, to which the at least one additional fluid path is connected. Consequently, functional components in the thermal management module can be placed directly on the fluid-conducting element and connected thereto.

A functional component can also be placed in at least one port. In this case, the component is a valve for opening and closing the port.

The channel plates and cover plates can be bonded to one another, preferably by brazing. Consequently, the channel structure in the fluid-conducting element can be obtained easily, such that it occupies a minimum of space. This also ensures that the channel structure is adequately sealed against the exterior.

A compressor can be placed in refrigerant circuit, specifically on the component mount. This results in a modular construction that can be installed in the motor vehicle, comprising the compressor and the thermal management module.

The closed refrigerant circuit, containing the compressor, can be filled with refrigerant before the thermal management module and compressor are installed in the vehicle. This also simplifies installment of the thermal management module in the vehicle.

The thermal management module can also contain a cooling module that can be integrated in the cooling circuit in the vehicle, which contains paths for the coolant. This cooling module can have one or more ports to which a vehicle component can be connected for cooling purposes. There can be coolant lines between the vehicle components and the cooling module, which are then connected to these ports.

The invention also relates to a motor vehicle that contains the thermal management module disclosed herein. The advantages obtained with the thermal management module also apply to the motor vehicle. The vehicle contains a separate coolant circuit from the refrigerant circuit, in which the two circuits are thermally coupled to one another by the two heat exchangers in the thermal management module. The vehicle also contains at least one component that can be cooled by the coolant circuit or the coolant therein.

In a preferred embodiment of the vehicle, the interior can be cooled by the coolant circuit or the coolant therein.

Other important features and advantages of the invention can be derived from the dependent claims, drawings, and descriptions of the drawings.

It is understood that the features specified above and explained below can be used not only in the given combinations, but also in other combinations or in and of themselves, without abandoning the scope of protection for the present invention.

Preferred exemplary embodiments of the invention are shown in the drawings and explained in greater detail below, in which the same reference symbols are used for identical, similar, or functionally identical components.

Therein, schematically:

FIG. 1 shows a perspective view of an example of a thermal management module obtained with the invention,

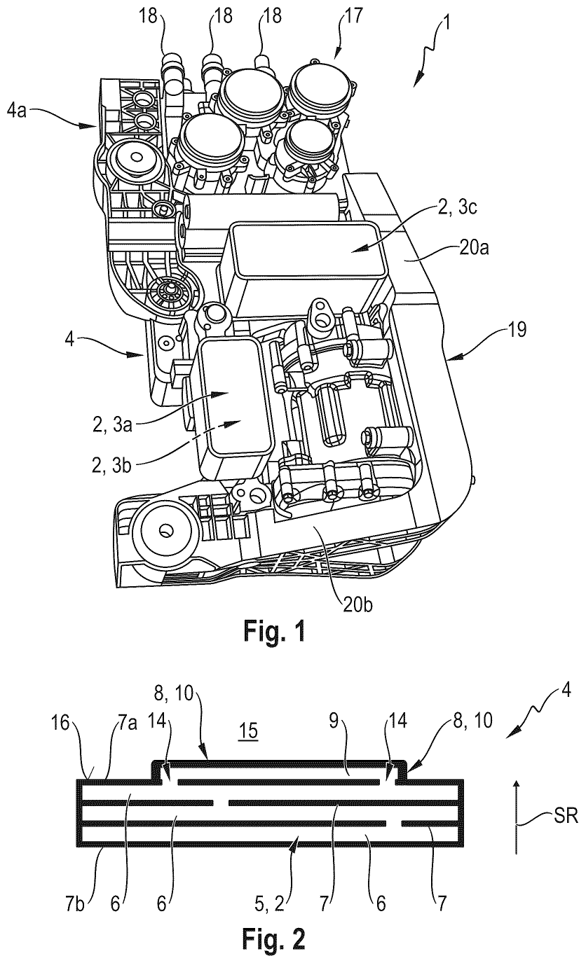

FIG. 2 shows a sectional view roughly illustrating the arrangement of the component mount and fluid-conducting element in the thermal management module from FIG. 1,

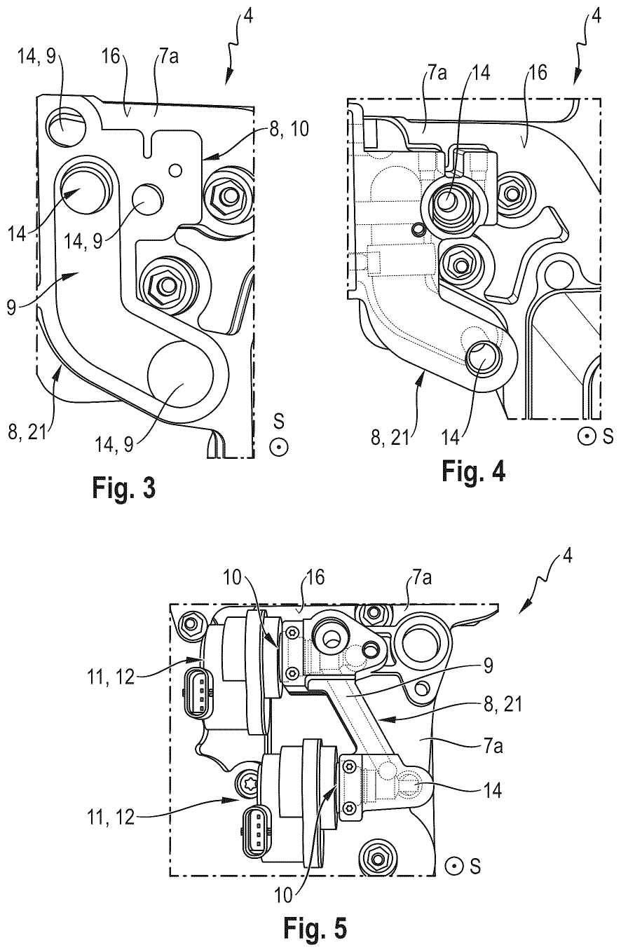

FIGS. 3, 4 show detailed illustrations of how the fluid-conducting element is placed on the component mount, and

FIG. 5 shows another design for the examples shown in FIGS. 1 to 4.

FIG. 1 shows a perspective view of an example of the thermal management module 1 obtained with the invention. This thermal management module 1 contains a closed refrigerant circuit 2 through which a refrigerant flows (not shown in detail in FIG. 1).

There are at least two heat exchangers 3a, 3b in the refrigerant circuit 2 for exchanging heat between the refrigerant and a coolant flowing separately through the heat exchangers 3a, 3b. This coolant circulates in a separate coolant circuit (not shown), in which the two heat exchangers 3a, 3b are located. The thermal coupling of the refrigerant circuit 2 to the coolant circuit is obtained in the two heat exchangers 3a, 3b.

The first heat exchanger 3a can be a condenser in which the refrigerant is condensed. The heat that is released can then be transferred to the coolant. The second heat exchanger 3b can be a chiller, in which the refrigerant is vaporized. The heat needed for this is obtained from the coolant. The two heat exchangers 3a, 3b can thus be used to control the temperature of the coolant. The coolant circuit can be thermally coupled numerous vehicle components.

As FIG. 1 shows, the thermal management module 1 contains a component mount 4 to which the two heat exchangers 3a, 3b are attached.

Other functional components of the thermal management module 1 can also be attached to the component mount 4. A compressor 13 for pressurizing the refrigerant in the refrigerant circuit 2 is also attached to the component mount 4 in the example in FIG. 1.

The first heat exchanger 3a can be discerned in FIG. 1, but the second heat exchanger 3b is concealed behind the component mount 4. The thermal management module 1 in FIG. 1 also has an additional heat exchanger 3c. The component mount 4 can be attached to a base 19, which is L-shaped in this case, with a first leg 20a, and second leg 20b at a right angle thereto.

The structure of the component mount 4 is explained in greater detail below in reference to FIG. 2. FIG. 2 shows a rough, highly simplified sectional view of the component mount 4 cut along the vertical plane SR.

The component mount 4 contains a channel structure 5 forming fluid paths 6 for the refrigerant. The channel structure 5 is within the refrigerant circuit 2, i.e. it forms part of the refrigerant circuit 2 in the thermal management module 1. This component mount 4 therefore comprises numerous stacked channel plates 7 between which the fluid paths 6 are formed. The channel plates 7 are between two cover plates 7a, 7b. The channel plates 7 and cover plates 7a, 7b are brazed to one another in this example. This seals the channel structure 7 against the coolant circuit and the exterior 15 of the component mount 4.

FIG. 2 shows that a fluid-conducting element 8 is placed on the first cover plate 7a, in which another fluid path 9 is formed. This fluid path 9 can be connected to the channel structure 5 in the component mount 4 by a hole 14 in the cover plate 7a (the fluid-conducting element 8 is not shown in FIG. 1 for purposes of clarity).

There could also be two or more such fluid paths 9. These fluid paths 9 can be interconnected or separated from one another. The fluid paths 9 can connect various components in the thermal management module to one another, including the heat exchangers 3a, 3b, 3c in the refrigerant circuit 2. The refrigerant in the refrigerant circuit 2 can be conducted to and from these components by this means.

FIGS. 3 and 4 illustrate one example of the thermal management module 1 obtained with the invention, with the component mount 4 and fluid-conducting element 8. The fluid-conducting element 8 is a separate component from the component mount 4. This fluid-conducting element 8 can be an extruded or cast component 21.

The fluid path 9 can be open toward the cover plate 9a, as shown in FIG. 2, and sealed by this cover plate 7a for the component mount 4. The fluid path 9 can be milled into the material forming the fluid-conducting element 8. The fluid-conducting element 8 can be on the outer surface 16 of the first cover plate 7a, facing away from the channel plates 7. The cover plate 7a and fluid-conducting element 8 can be bonded to one another to seal the fluid path 9, specifically with an adhesive or through brazing.

The cooling module 17 can be attached to an additional component mount 4a.

FIG. 5 shows another design of the examples shown in FIGS. 1 to 4, showing part of the thermal management module 1 from above, looking down at the first cover plate 7a for the component mount 4 in the vertical direction SR. the fluid-conducting element 8 on the first cover plate 7a can be clearly seen. This is partially transparent in FIG. 5, in order to be able to see the fluid path 9 in the fluid-conducting element 8.

FIG. 5 also shows two ports 10 on the fluid-conducting element 8, into which the fluid path 9 opens at each end, thus connecting them to one another. The hole 14 in the fluid path 9 can also be seen in FIG. 5, via which the fluid path 9 is connected to the channel structure 7 (not shown in FIG. 5) in the component mount 4.

There is a functional component 11 in the form of a valve 12 in each of the ports 10 in FIG. 5. The valves 12 can open and close the ports 10 they are in.

The thermal management module 1 explained above in reference to the drawings can be part of a motor vehicle (not shown) obtained with the invention, which contains a coolant circuit that is separate from the refrigerant circuit 2 in the thermal management module 1. In this case, the coolant circuit and refrigerant circuit 2 are coupled to one another in the two heat exchangers 3a, 3b in the thermal management module 1.

The thermal management module 1 shown in FIG. 1 can also contain a cooling module 17 that is incorporated in the coolant circuit (not shown), with a fluid path (not shown) through which coolant can flow. This cooling module 17 can contain one or more ports 18 to which the vehicle components (not shown) that are to be cooled can be connected. There can be coolant lines (not shown) for this between the vehicle components and the cooling module 17, which are connected to the respective ports 18.

The explanations for cooling vehicle components apply mutatis mutandis for cooling the vehicle interior connected to the coolant circuit.

The specification can be readily understood with reference to the following Numbered Paragraphs:

Numbered Paragraph 1. A thermal management module (1) for a motor vehicle that has
a closed refrigerant circuit (2) with at least two heat exchangers (3a, 3b) for exchanging heat between the refrigerant and a coolant flowing separately through the heat exchangers (3a, 3b),
a component mount (4) to which at least one of the heat exchangers (3a, 3b) is attached,
   wherein
a channel structure (5) with at least two fluid paths (6) in the refrigerant circuit is formed in the component mount (4),
the component mount (4) contains at least two vertically (SR) stacked channel plates (7) forming the channel structure (5), which are between two cover plates (7a, 7b),
a separate fluid-conducting element (8) is placed on the first cover plate (7a), in which at least one more fluid path (9) is formed that is connected to the channel structure (5) in the component mount (4).

Numbered Paragraph 2. The thermal management module according to Numbered Paragraph 1, characterized in that the fluid-conducting element (8) is an extruded or cast component (21).

Numbered Paragraph 3. The thermal management module according to Numbered Paragraph 1 or 2, characterized in that at least one additional fluid path (9) in the fluid-conducting element (8) is open, which is sealed by the first cover plate (7a) in the component mount (4).

Numbered Paragraph 4. The thermal management module according to any of the Numbered Paragraphs 1 to 3, characterized in that at least one other fluid path (9) is milled into the material forming the fluid-conducting element (8).

Numbered Paragraph 5. The thermal management module according to any of the preceding Numbered Paragraphs, characterized in that there is at least one port (10) on the fluid-conducting element (8) for connecting to a functional component (11) in the thermal management module (1), which is connected to at least one other fluid path (9).

Numbered Paragraph 6. The thermal management module according to any of the preceding Numbered Paragraphs, characterized in that at least one port (10) contains a functional component (11), and this functional component is a valve (12) for opening and closing the port (10).

Numbered Paragraph 7. The thermal management module according to any of the preceding Numbered Paragraphs, characterized in that the channel plates (6) and cover plates (7a, 7b) are bonded together by brazing.

Numbered Paragraph 8. The thermal management module according to any of the preceding Numbered Paragraphs, characterized in that there is a compressor (13) for compressing the refrigerant is placed on the component mount (4) in the refrigerant circuit (2).

Numbered Paragraph 9. A motor vehicle that has
a thermal management module (1) according to any of the preceding Numbered Paragraphs,
a coolant circuit separate from the refrigerant circuit (2) in the thermal management module (1), wherein the coolant circuit and refrigerant circuit (2) are thermally coupled to one another in the two heat exchangers (3a, 3b) in the thermal management module (1),
at least one vehicle component that can be cooled by the coolant circulating in the coolant circuit.

Numbered Paragraph 10. The motor vehicle according to Numbered Paragraph 9, characterized in that it has an interior that can be cooled by the coolant circulating in the coolant circuit. LIST OF REFERENCE SYMBOLS
1 thermal management module
2 refrigerant circuit
3a, 3b first and second heat exchangers
4 component mount
4a additional component mount
5 channel structure
6 fluid path
7 channel plate
7a, 7b first and second cover plates
8 fluid-conducting element
9 fluid path
10 port
11 functional component
12 valve
13 compressor
14 hole
15 exterior
16 outer surface
17 cooling module
18 coolant port
19 base
20a, b first and second legs
21 component
SR vertical direction

1-10. (canceled)

11. A thermal management module for a motor vehicle, comprising a closed refrigerant circuit with at least two heat exchangers configured for exchanging heat between the refrigerant and a coolant flowing separately through the heat exchangers, a component mount to which at least one of the heat exchangers is attached,
further comprising a channel structure with at least two fluid paths in the refrigerant circuit formed in the component mount, the component mount comprises at least two vertically stacked channel plates define the channel structure, the channel plates are disposed between two cover plates, a separate fluid-conducting element is disposed on the first cover plate, in which at least one additional fluid path is defined that is connected to the channel structure in the component mount.

12. The thermal management module according to claim 11, wherein the fluid-conducting element is an extruded or cast component.

13. The thermal management module according to claim 11, wherein the at least one additional fluid path in the fluid-conducting element is open, wherein the additional fluid path is sealed by the first cover plate in the component mount.

14. The thermal management module according to claim 11, wherein the at least one additional fluid path is milled into the material forming the fluid-conducting element.

15. The thermal management module according to claim 11, further comprising at least one port on the fluid-conducting element for connecting to a functional component in the thermal management module, the at least one port is connected to at least one additional fluid path.

16. The thermal management module according to claim 15, wherein the at least one port contains a functional component, wherein the functional component is a valve configured for opening and closing the port.

17. The thermal management module according to claim 11, wherein the at least two channel plates and the two cover plates are bonded together by brazing.

18. The thermal management module according to claim 11, further comprising a compressor that is placed on the component mount in the refrigerant circuit.

19. A motor vehicle comprising a thermal management module according to claim 11, and further comprising a coolant circuit separate from the refrigerant circuit in the thermal management module, wherein the coolant circuit and refrigerant circuit are thermally coupled to one another in the at least two heat exchangers in the thermal management module, further comprising at least one vehicle component that can be cooled by the coolant circulating in the coolant circuit.

20. The motor vehicle according to claim 19, further comprising an interior that is configured to be cooled by the coolant circulating in the coolant circuit.
